(19) United States
(12) Patent Application Publication
(10) Pub. No.: US 2020/0065780 A1
(43) Pub. Date: Feb. 27, 2020

(54) SafePay Process

(71) Applicant: Gaurav Sharma, New Delhi (IN)

(72) Inventor: Gaurav Sharma, New Delhi (IN)

(21) Appl. No.: 16/612,735

(22) PCT Filed: May 11, 2018
(86) PCT No.: PCT/IB2018/053288

§ 371 Date: Nov. 11, 2019

(30) Foreign Application Priority Data
May 11, 2017 (IN) 201711016641

(51) Int. Cl. G06Q 20/04; G06Q 20/02

(52) U.S. Cl. CPC G06Q 20/042; G06Q 20/023

(57) ABSTRACT

Described is a Cheque (aka Check) Clearing Process and System with ability to process payments of such issued Cheques in real time, Cheques being the e-Cheques or physical Cheques issued by a Bank (or such financial Institution that may or not be a Regulated Entity) to an Entity (including Individuals/Persons). The said Cheque having been provided to such Entity by such Bank (s) and in turn signed as a ‘Drawn Note’ to said Bank for immediate payment across the counter for cash to Self or Bearer or Payee, mentioned as Beneficiary or crediting some other account of self or Payee. The described process makes redundant, practice of large clearing houses which were created to facilitate rapid settlement of such Negotiable Instruments/Notes, having become more of a bottleneck today, due to massive volumes (in billions) of such instruments used annually.

### FIELD OF INVENTION

SafePay's innovative, User Driven Cheque (aka Check) Clearing Process and System has the ability to securely process payments of such issued Cheques in real time, Cheques being e-Cheques or physical Cheques issued by a Bank (or such financial Institution that may or not be a Regulated Entity) to an Entity (including Individuals/Persons).

SafePay's inventive process makes redundant, practice of large clearing houses which were created to facilitate rapid settlement of such Negotiable Instruments/Notes, having become more of a bottleneck today, due to massive volumes (in billions) of such instruments used annually.

SafePay is an inventive step to check frauds in Bank Cheques wherein the fraud gets noticed only once the Account of a Cheque Issuer gets debited

SafePay is an inventive step with the clear ability of processing Cheque Payments in Real Time to Bank Account of the Cheque Holder

SafePay is an inventive step with the clear ability to make cash available anytime, anywhere, by processing Cheque Payments in Real Time and utilizing existing ATM and technology infrastructure

### BACKGROUND OF INVENTION WITH REGARD TO DRAWBACKS ASSOCIATED WITH KNOWN ART

Over years, Banking has assumed a critical role in everyone's life, even though it is a fairly simple process of holding and returning assets of a User as and when requested/demanded by said User. The assets range from money to food grains to stock to metals and what not. It would not be wrong to say that if there is an Asset, it can be banked. We shall refer to (but not limit to) Money Transactions hereafter.

Today, Banking has grown into a super-complicated process wherein an Institution (i.e. a Bank) allows opening of an ‘Account’ of an Entity/User (an Individual or an Institution). User is allowed to deposit money through Cash or Cheques into his/her/their Account and conversely User is allowed to transact (withdraw/transfer) on available money in his/her/their Account through different Banking procedures.

Cheques (or Checks) being such an instrument used for transacting in/with banks, definitely most common as well, are known to have existed in 9th century (some claims of even 1 BCE), even when the first known money bank started in 1472. One of oldest known Cheques, signed by Thomas Jefferson in 1809 had simple and essential information like:

Drawee bank name and place

Date of signing the Cheque

Payee's name

Amount in words and figures

Signatures of the payer (in this case, Thomas Jefferson)

The said Cheque having been provided to such Entity by such Bank (s) and in turn signed as a ‘Drawn Note’ to said Bank for immediate payment across the counter for cash to Self or Bearer or Payee, mentioned as Beneficiary or crediting some other account of self or Payee.

However, this instrument has evolved and matured over years significantly, basic details obviously getting retained. Need based additional information has got added and so has design and aesthetics. Today's Cheque, along with above basic details also carries (may change from bank to bank though):

Cheque Number

SWIFT Code

IFSC Code

MICR Code

These BICs conform to ISO 9362 standards and thus allow banking transactions and settlements to happen across the world. Technology has facilitated, eased and speeded up transactions.

Banks have a continuous dilemma of striking a fine balance between safeguards/security vis-à-vis convenience. However, it is common knowledge that such cautionary steps turn banking system into more restrictive than as adaptive or supportive processes. This may indeed be required since number of Cheque transactions are in billions in a year across the world.

To safeguard deposited money, banks impose numerous safeguards to be assured themselves that they are not just paying the right person, but also debiting the right person as well.

Other than this, banks have to assure both parties as well on transactions that they are doing/allowing to happen, but unfortunately, there is a big, blind period between depositing a Cheque today and receiving its credit, where neither Cheque Issuers nor Cheque Receivers know when exactly the Debit-Credit transaction would happen. This results in a chain reaction at times leading to dishonoring of such Cheques due to insufficient funds in Cheque Issuers' Bank account.

It is also often seen that this gap is utilized for intentional dishonor of Cheques by Cheque Issuers knowing very well that said Cheque would not be honored by their respective bank if discrepancies are found (including signatures or wrong dates or unavailability of required funds).

Further there are Regulatory requirements guiding banks to inadvertently or as a result of some conspiracy, not get befooled by criminals ranging from petty fraudsters to money launderers.

A primary way to do so is to check the document submitted-like a Cheque, checking all details provided and then also check the signatures that is ‘supposedly’ known only to the Cheque Issuer and the Bank (during the Account Opening Process).

However, it is well known that no one's signatures are supposedly that ‘secret’ and hence it is very much possible to copy such signatures. Banks on their part are helpless to clearly differentiate a real signature of a person, done by the original owner, from real signatures of the original owner, but actually done by an impersonator (s).

It is also a known issue that signatures change over a period of time owing to age/anatomical changes of said User.

Bankers are not trained forensic experts, but do get skilled on some level of fraud-detection. However, this becomes a huge risk rather than an asset.

Further, internal frauds or connivance of bank employees with others is also routine if not sporadic. It is a risk that is contained, but this containment is relative to risk appetite of the said Bank.

Keeping aside the security flaws in dealing with Cheques, a real person has to go through multiple and non-value add processes in order to either pay someone or receive funds from someone or even withdraw cash over the counter as bearer of a Cheque.

Additionally, menace of dishonored Cheques unnecessarily draw banks in consequent litigation, with huge number of such cases pending across courts in the world for amounts ranging from petty to huge amounts. This happens sometimes willingly as well, humble Cheque becoming an accessory or a tool for fraudsters. It is equally important to note the huge amount of time, money and effort of Banks that get wasted without serving any purpose.

It is thus taken for granted that frauds happened in past and shall thus continue to happen in future. Each restrictive practice further adding to misery of customers and simultaneously adding waste in entire process through non-value addition of effort and unnecessary digital records.

In a nutshell, the humble Cheque is a boon and bane as well.

As is common knowledge, existing solutions are fundamentally flawed, delay-prone, non-secure, and non-value adds for a Customer. It is also well known that no bank provides Instant Cheque Payment-even for its own issued Cheques to its own customers and everything is routed through Clearing Houses having required ‘expertise’, yet delays and blind wait in Cheque clearing are routine.

Thus, described is SafePay, A Cheque Clearing Process and System which is capable of processing payments of such issued Cheques (physical or e-Cheques) faster than existing processes and possibly, in real time. The SafePay Process generates a SafePay ID that is issued once and only once the Signatory of the said Cheque has authenticated the details mentioned in the said Cheque (details including the pre-printed Cheque as provided to the said signatory by the bank).

### OBJECT OF INVENTION

The humble check that has seen only a few changes over centuries of usage. Even though the Cheque usage is on the decline, with some countries completely eliminating Cheque Processing owing to very less volumes of Cheque based transactions, the humble Cheque remains as the symbol of Trust and an object of control for the Cheque Receiver.

With the advent of Electronic Fund Transfers and Digital Wallets, Cheque Transactions were expected to be finally laid to rest. However, with decades of usage of such Digital Medium for monetary transactions, Cheques have remained in usage, though the year—on—year decline is evident.

An objective if the invention is to bring this humble cheque into digital transaction fold and let Cheque users derive the benefits of digital technologies for Cheques as well. This is achieved by generation of an SPID (SafePay ID) that gets generated once and only once a Cheque Issuer authenticates the cheque, provided by a Cheque Provider (like a Bank) and its details received as a request from Cheque Receiver. This SPID gets utilized just once, but through multiple innovative options.

### STATEMENT OF INVENTION

An innovative Cheque Payment Process with the ability to execute Cheque Payments (both Physical and Virtual Cheques) in real time, with the additional convenience of receiving Cash at ATMS and also having the ability of giving Cheque Payment Process a good riddance from sole dependency on cheque providing Bank, on the basis of a secure, single-use SPID. In effect, Trust is gained, Trust is transacted and Trust is ensured.

### SUMMARY OF INVENTION

SafePay is an innovative real time cheque payment process that is executed in a closed ended, secure eco-system and between three defined Roles i.e.:

Cheque Receiver: An entity who has received a Cheque from a Cheque Issuer

Cheque Issuer: An entity who has signed on the said Cheque to the said Cheque receiver

Cheque Provider: An entity, usually a bank, which has Authenticated the above two role holders to have an existing account with the bank.

The SafePay process, simply put eliminates the insecure practice of a Bank verifying the said cheque, letting the Issuer alone Authenticate the same. This results in generation of a single-use, unique and secure SPID (SafePay ID)

The SPID could then be used by Banks to execute the Debit-Credit transaction, through defined mechanisms of legacy cashier payment or legacy truncation system processes or through innovative API Based automated payment process or innovative ATM based payment process.

On the whole, the SafePay is an innovative method for not only innovative Cheque Authentication and Payment Process, where Authentication is carried out by single source of truth i.e. Cheque Issuer and NOT Verification by a bank, but it also ensures possibilities of Cheque related frauds (including dishonored cheques) become negligible.

At the same time, banks stand to gain by significant reduction in associated costs

This makes this innovative process a win-win process for all involved parties—Cheque Receiver, Cheque Issuer and Cheque Provider . . . in multiple ways.

### DETAILED DESCRIPTION

SafePay, a closed ended secure eco-system, allows users to undertake monetary transactions through their Cheques, provided to them by their bank, without ever having the need to go to the said bank in person/proxy/post etc.

SafePay is an information technology driven system. SafePay utilizes multiple forms of technologies, but is still completely independent of current and future information technology infrastructure, including servers, computing devices like computers, tablets, mobile devices etc. and also independent of coding nomenclature, techniques and practices and also independent of cybersecurity techniques such as tokens, encryption technologies, digital signatures etc. Innovative SafePay, simply uses technology as an enabler.

This innovative system comprises of only three roles—Cheque Receiver, Cheque Issuer and Cheque Provider. Being a closed ended eco-system, users of all three roles register on the SafePay system.

For clarity, the distinct SafePay roles are explained as follows:

Cheque Receiver: An entity who has received a Cheque from a Cheque Issuer and wishes to draw funds in cash or credit an account by presenting the said Cheque

Cheque Issuer: An entity who has issued the said Cheque to the said Cheque receiver as the signatory for the bank account which shall be consequently debited

Cheque Provider: An entity, usually a bank, which has provided the said Cheque as a Pre-Printed stationery to the Cheque Issuer and has the ability to provide funds as mentioned on the said Cheque as cash or credit the account of the said Cheque Receiver, once the required diligence and regulatory aspects have been met.

Without prejudice, all roles are available to all users of this system, however, there shall always be a straight-line relationship between each of these roles, independent from other relationships, i.e. at no point, a particular transaction would involve more than two roles.

It must also be noted that Banks being Cheque Providers may also be the Cheque Issuers or Cheque Receivers in some cases, but would still not be able to execute all possible straight-line transactions (of Cheque Submission, Authentication and Credit-Debit) through a single role. Such Bank would be able to use only either of the available/registered for roles at a single point of time (i.e. stated/selected while logging in to system).

Similarly, Cheque Receiver may also be Cheque Issuer of the same Cheque (though this transaction would be meaningless), but similar to situation explained in [58], one User would be able to login to system through one Role at any given point of time.

The system derives its strength from its Authentication Architecture (Not Verification of available data alone), wherein, Only the Single Source Of Truth is able to declare absolute Authenticity when requested by an entity. SafePay System's impregnable architecture, where each Authentication is carried out only once and a unique Authentication ID is generated for each such successful Authentication. In disclosures that follow, we shall clearly see multiple steps, but each one being an Authenticated step. So, it is not multi-Authentication, but Authenticated Multiple Steps-all executed just once. This is because, each of the Authentication IDs that get generated are single-use, yet referable and cannot be repudiated.

SafePay Registration: Simple step of registration and selection of any of three roles. Prevalent User Authentication mechanisms, ranging from something as simple as a set of unique username+password to inclusion of a mobile number/e-Mail OTP to more advanced (not necessarily required or to be seen as more secure) biometric system based to linking with different Identity Service Providers like highly secure CertiSafe service or even Aadhar (UIDAI Service) or a combination of such systems.

SafePay Authorization: Cheque Receiver as well as Cheque Issuer users requests their respective Banks (Cheque Provider), to Authenticate their Bank Account Details. This Authentication step is also undertaken just once and cannot be repudiated by any of Users.

SafePay Usage: A Simple 3-Step, defined process disruptively transforms existing Cheque payment processes, explained below:

Cheque Receiver: Uses any of the ‘Cheque Submit’ processes (detailed in [69]). This results in the said Cheque reaching the said Cheque Issuer for Authentication, eliminating no-value existing process (es) of Banks verifying said details. This redundant step is mentioned as no-value, since it is at this point alone that frauds go unnoticed and an undesired action actually becomes a fraud.

Cheque Issuer: Said Cheque with required details is now available to Cheque Issuer for Authentication and uses any of available options (detailed in [73]). This step elevates the standards and security of Cheque Transaction, since only related parties (Cheque Receiver and Cheque Issuer) are involved in the Authentication Process.

Cheque Provider: Cheque Provider, like Cheque Receiver has multiple options to execute Debit (to Cheque Issuer)—Credit (for Cheque Receiver) transactions and are detailed in [80]. This step, restricts Cheque Provider to only Debit-Credit transaction, further raising process hygiene, operating standards as well as security since now only related parties can transact, in two consequent, but independent stages:

Stage 1: The said Cheque has been provided by Cheque Provider to Cheque Issuer, hence can be relied and cannot also be repudiated. Be it noted that third entity, Cheque Receiver is not involved.

Stage 2: Post Authentication, Cheque Provider executes Debit-Credit transaction-again one at a time, once with Cheque Issuer only (Debit) and then with Cheque Receiver only (Credit).

Cheque Submit Processes: Cheque Receiver has multiple options to choose from, purely depending on User's choice, convenience and comfort. It is also dependent on Cheque Provider to agree in making these available, conforming to existing or future Regulatory agreements.

Template based: Through this option, Cheque Receiver simply selects a template (blank format) of the Cheque of Cheque Provider, fills in details as seen in received Cheque and submits this virtual Cheque to Cheque Issuer for authentication of the said Cheque.

Image based: Through this option, Cheque Receiver simply creates/clicks an image of received Cheque, post which defined OCR software leeches out requisite data and optionally submits to Cheque Receiver for review. Once reviewed and any possible corrections done, said details are then submitted to Cheque Issuer for Authentication.

Details based: Depending on technology maturity of Cheque Provider, Cheque Receiver simply fills in details as seen in received Cheque and submits it to Cheque Issuer for authentication of said Cheque. These captured details are then sent to Cheque Issuer of the said Cheque (or even bank) for Authentication.

Cheque Authentication Process: SafePay's architecture has clearly defined outcomes-Authenticate or Decline, since other than Cheque Issuer, no one really can Authenticate having issued the said Cheque for undertaking the monetary aspects of a transaction for which the said Cheque has been issued. Following options would be available to Cheque Issuer, but each option culminates finally into any of two outcomes only as defined before:

Authenticate: Once and only once Cheque Issuer Authenticates, a unique SPID (SafePay ID) gets generated which in effect is ‘Authenticate and Pay’ action mandated by Cheque Issuer. It should be pointed out here that there are two critical Safe Guards built in SafePay for security: (these are optional though and dependent on the technology maturity of the Cheque Providers as they can be undertaken through different mechanisms).

Cheque Number Availability: Through this, the Cheque Provider is able to provide valid a declaration that the designated Cheque bearing a particular Number (and as submitted by the Cheque Receiver) was indeed issued to the Cheque Issuer in the first place.

Availability of funds being transacted: Through this, Cheque Provider is able to provide a valid declaration that the designated amount of funds being transacted through the said Cheque are indeed available as ‘clear funds’ with Cheque Issuer and on subsequent authentication by the Cheque Issuer, such funds shall be locked and released only to the Cheque Receiver in the way Cheque Receiver opts for.

Decline: Request for Authentication is returned to Cheque Receiver for further actions, if required.

Hold/No Action: Cheque Issuer is able to put this Authentication Request on Hold and execute the same later.

Defer Payment: The Cheque Issuer is able to Authenticate, but holds the release of unique SafePay ID. It must be noted that though the system shall accommodate the Authentication decision of the Cheque Issuer, but SafePay ID would have to be released by the Cheque Issuer only, by a direct action. This may be due to situations wherein Cheque Issuer is aware of insufficiency of funds, at that point of time. SafePay system would not automatically release SafePay ID on the deferred date, but only provide an option to Close and Pay immediately, an action which shall have to be taken by Cheque Issuer alone. This shall be particularly helpful for Cheque Receivers who have received postdated Cheques.

Debit-Credit Transaction: Cheque Provider, through the outcome as achieved through [73] has following options:

Physical Cheque Processes: Once Authenticated by said Cheque Issuer, the funds need to now change owners, effectively the funds need to be paid to the Cheque Receiver through any of following options:

Over The Counter Pay Cash: A simple process, wherein Cheque Provider, provides Cash to Cheque Receiver upon debiting Cheque Issuer's account immediately. The transacted Cheque is then updated in all relevant records accordingly. This is to ensure that same Cheque is never presented or attempted to be presented again through SafePay or any of other bank processes.

Over The Counter Credit to Cheque Receiver's Account: Instead of paying cash, Cheque Provider simply credits the account of Cheque Receiver. The transacted Cheque is then updated in all relevant records accordingly, preventing re-use of the said Cheque.

Electronic Processes: Utilizing API based transaction processing would remove existing bottlenecks of time, place and volume. It is common knowledge that human-action-based Cheque Clearing Process, including Clearing Houses or different Cheque truncation Processes/Systems, involuntarily induce a lag due to defined working hours or transport of physical Cheques or sudden variations in the volume of in-process Cheques. SafePay envisages changing preferences and provides the following options:

Pay Cash Through ATM Automatically: A simple process, wherein Cheque Receiver, having a SafePay ID, is able to withdraw Cash from ATMs of the said Bank at any time Cheque Receiver so pleases, by punching the SafePay ID that gets generated once all compliances have been met. Once the transaction is carried out at the ATM, the Cheque Issuer's account is debited instantly. The transacted Cheque is then updated in all relevant records accordingly.

Pay Cash Through Code Based ATM Transaction: A simple process, wherein Cheque Receiver, having a SafePay ID, also gets a unique Lock and Pay PIN Code (set by Cheque Issuer), once said Cheque is Authenticated and Marked as Lock and Pay. This Unique Pin is set by the Cheque Issuer and is used in conjunction with the PIN of Cheque Receiver's ATM Card PIN and an OTP. These PINs and OTPs are not limiting factors for this option, but significantly add to the security of in-progress transaction.

Additionally, as shown in [85] and [86], the Cheque Receiver may use the ATM but may choose to fund his/her/their Account instead of withdrawing Cash

As highlighted in [85], [86] and [87] the ATM Transactions could be Bank independent since Banks have requisite ATM Transaction settlement processes with other Banks and can be easily settled through defined accounting procedures, wherein at any point of time the total debits would balance out total credits.

Pay Cash Through ATM: As highlighted in [85], existing Regulations may additionally require the said Cheque to be deposited at the ATM or Bank. In such cases, once the said Cheque is received and validated by the said Bank to be complying to all Regulatory and Internal Processes' requirements, for closure, Lock and Pay process could result in generation of a unique Lock and Pay Code that could be punched in the ATM Machine to draw the authorized amount in cash as shown in [86].

Crediting Cheque Receiver's Account: Instead of expecting Cheque Receiver to visit a bank branch and then undertake a non-value add process of filling up Pay-In Slip' mentioning particulars of the said Cheque among other details, Cheque Provider can execute the Debit-Credit Transaction instantly on receipt of a SafePay ID. The transacted Cheque is then updated in all relevant records accordingly.

Technical and Regulatory Maturity of Cheque Provider: Not limiting SafePay in any way, Technological and Process maturity are critical in defining User experience. An important aspect wherein Banks or Regulators acknowledge that existing processes (or that have got built over time as quick-fixes or got created for want of better alternatives or infancy of technology then, etc.) have thus not kept pace with changing times or Customer Satisfaction (Account Holders) has become zero priority in relation to other priorities, Banks and Regulators can review the following:

Physical Cheque Presentation: Currently and always, in consonance with existing Regulations or approvals thereof, Cheque Provider may allow depositing the Cheque at any Branch for consolidation as per existing process or may eventually even do away with such redundant process that are non-value add in the first place. This is owing to the fact that the Cheque Number of the said Cheque would automatically get updated in records to prevent re-use and Digital Copy of the said Cheque, that too Authenticated and which cannot be repudiated is available in SafePay/Bank's records.

Any Bank V/s Own Bank: Currently and always, in further consonance with existing Regulations or approvals thereof, Cheque Receiver may be allowed to present the said Cheque in any Bank, irrespective of Cheque Receiver having an account in the said Bank. This is owing to the fact that each and every particular of the said transaction is available electronically, cannot be repudiated, and is a matter of simple accounting which can be achieved through simple APIs and requires no human-participation.

Cheque Receiver's Delight:

Stale Cheque Utilization: As an additional option, Cheque Receiver may have an option to submit a stale Cheque (past its validity date) and Cheque Issuer can still Authenticate it, SPID generated, actual debit-credit transaction carried out

Authenticated Cheque Guarantee: As an additional option, Cheque Receiver also has an option to use the same as a guarantee even if subsequent transactions of credit and debit of accounts have not been carried out or requested for, as planned. In such cases, the Cheque Issuer's account is debited, while the funds so debited are kept locked by the Cheque Receiver's Bank and a guarantee for such funds issued.

Authenticated Cheque's Optimized Usage: As an additional option, Cheque Receiver will also have the option to move the received credit automatically to a different account/deposit/payment schedule (like bills/fee etc.,) thus significantly speeding up such processes significantly and reducing loads on associated systems. The said funds after all are now Cheque Receiver's funds, which need to be put to use optimally-without the rigmarole of incessant repetition.

User Control—Cheque Receiver: Cheque Receiver thus has complete knowledge and control over the process rather than a Bank—a third party in the current banking scenario.

Cheque Issuer's Delight:

Zero Dishonor: Through SafePay, no Cheque is ever returned for lack of funds and embarrassment or litigation permanently avoided.

Define Future of Payments: Cheque Issuer, can define Cheque Payment Validity (not referring to Cheque Date) of submitted Cheque for carrying out the actual debit-credit transaction

User Control-Cheque Issuer: Cheque Issuer may also have the option to debit the required amount automatically from a different account/deposit/instrument, thus speeding up the process significantly and reducing loads on associated systems.

Cheque Issuer gets to check the Account from which the Cheque has been issued. Cheque Issuer gets the viable option of changing the Account to be debited for execution of Debit-Credit transaction.

As an additional option, Cheque Issuer after checking the Account from which the Cheque has been issued, gets a practical option of moving funds from another Account for execution of Debit-Credit transaction.

As an additional option, Cheque Issuer gets to check signatures on the Cheque, if signed. In cases of virtual or e-Cheques, signatures would be redundant.

As an additional option, in order to strike a balance between available funds—scheduled payments—honoring the said Cheque issued to the said Cheque Receiver, Cheque Issuer gets to part clear the total payment. In this option, Cheque Issuer can define the time by when full payment could be realized.

Advantages of ‘SafePay Process’

Since Cheque Issuer has indeed issued the said Cheque, said Cheque Issuer will not have any reasons to not to authenticate the same. Once required authentication is done, only then a unique SPID is generated and Cheque Receiver informed.

Trust is gained, Trust is transacted and Trust is ensured

SafePay Transactions are not just non-ambiguous, but are exact as well

Cheque Receivers as well as Cheque Issuers will thus be able to completely avoid basic Cheque issues/mistakes like (but not limited to):

Loss of Cheques

Incorrect dates

Stale Cheques

Insufficient funds

Clash of payments

Incorrect account number

Clerical mistakes of both Cheque Receiver and Cheque Issuer

Clerical mistakes of banks involved

Other than above, following are consequential of this process:

Zero possibility of a Cheque Issuer being debited in blind (Reduction in frauds)

Zero delays in Cheque based payments—24×7 availability (Customer Delight)

Zero corrections in Cheques (Certainty Delivered)

Zero possibility of forgery in Cheques due to eco-system level forgery alert (Reduction in frauds)

Zero chances of embezzlement of Cheques by a third party (Reduction in frauds)

Zero Identity Thefts or forged identity due to addition of authentication and privacy layers (Enhanced Security and Privacy)

Zero penalties that are otherwise levied if a Cheque is returned/bounced (Redundant process)

Zero pay-in slips that are required at branch level, reducing paper usage (Redundant process)

Zero or insignificant pendency of Cheques with Cheque Receivers/Cheque Issuers/Banks (Redundant process)

Zero impact due to bank holidays/non-public dealing days (Redundant process)

Zero possibility of postal delays (Redundant process)

Zero bank related mistakes (inadvertent or voluntary) like wrong credits or unauthorized account usage (Reduction in frauds)

Zero possibility of duplicate Cheques being used through this process (Reduction in frauds)

Zero possibility to repudiate any transaction (Reduction in frauds)

Increased control/better management of bank accounts for both Cheque Receivers and Cheque Issuers since both Cheque Receiver and Cheque Issuer are solely responsible for their actions/confirmatory actions on Authentication and subsequent transactions (Reduction in frauds)

Increased privacy and confidentiality due to reduced human interaction at bank level (Customer delight and Reduction in frauds as well)

Enhanced security of used Cheques due to overall reduction in number of Cheques in process (Customer Delight and Reduction in frauds as well)

Reduced financial risks for banks due to lesser responsibilities on banks involved, since transactions carried out by two entities (Cheque Receivers and Cheque Issuers) directly in a straight-line relationship (Reduction in frauds)

Reduced need for storage of used Cheques and Reduction load on branches and overall at bank level (Cost Savings and Reduction in frauds)

Reduced load on Cheque clearing houses individually and at a consolidated level (Customer Delight and Cost Savings)

Reduced reliance on/usage of forensics, since frauds would be reduced (Cost Savings)

Reduction in spurts in clearing houses, thus lesser delays even during sudden/irregular voluminous Cheque handling (Customer Delight and Cost Savings)

Post-dated Cheques (PDCs)—single/multiple—need to be authenticated just once and transactions could be executed at defined times (Customer Delight)

I claim:

1. A Say pay process of conclusively a bank Cheque comprising Cheque Receiver, Cheque Issuer and Cheque Provider being a closed ended eco-system, users of all three roles register on the SafePay system, for completion of a transaction and generation of an SPID (SafePay ID) is initiated that gets generated once and only once a Cheque Issuer authenticates the cheque, provided by a Cheque Provider and its details received as a request from Cheque Receiver.

2. A Safe pay process as claimed in claim 1, wherein Cheque Receiver, having a SafePay ID, is able to transact over The Counter Pay Cash, wherein Cheque Provider, provides Cash to Cheque Receiver upon debiting Cheque Issuer's account immediately.

3. A Safe pay process as claimed in claim 1, wherein Cheque Receiver, having a SafePay ID, is able to transact Over The Counter Credit to Cheque Receiver's Account Instead of paying cash, Cheque Provider simply credits the account of Cheque Receiver.

4. A Safe pay process as claimed in claim 1, wherein Cheque Receiver, having a SafePay ID, is able to transact through Electronic Processes Utilizing API based transaction.

5. A Safe pay process as claimed in claim 1, wherein Cheque Receiver, having a SafePay ID, is able to withdraw Cash or transfer the said amount to account from ATMs of the said Bank at any time Cheque Receiver so pleases, by punching the SafePay ID that gets generated once all compliances have been met.

6. A Safe pay process as claimed in claim 1, wherein Cheque Receiver, having a SafePay ID, is able to transact through Pay Cash Through Code Based ATM Transaction with A simple process, wherein Cheque Receiver, having a SafePay ID, also gets a unique Lock and Pay PIN Code.

7. A SafePay process as claimed in claim 1, which allows the Cheque Issuer to execute part payment, deferred payment and postdated payment of a request received from Cheque Receiver.

8. A SafePay process as claimed in claim 1, of enabling Cheque Issuer to effortlessly authenticate the request of Cheque Receiver by providing relevant details such as Template Based cheque details, valid Cheque Number and Funds Availability
